(19) United States
(12) Patent Application Publication
(10) Pub. No.: US 2008/0077774 A1
(43) Pub. Date: Mar. 27, 2008

(54) Hierarchical parallelism for system initialization

(76) Inventors: Lyle E. Cool, Beaverton, OR (US); Vincent J. Zimmer, Federal Way, WA (US)

Correspondence Address: TROP PRUNER & HU, PC, 1616 S. VOSS ROAD, SUITE 750, HOUSTON, TX, 77057-2631, US

(21) Appl. No.: 11/527,357

(22) Filed: Sep. 26, 2006

(51) Int. Cl. G06F 9/40

(52) U.S. Cl. 712/212

(57) ABSTRACT

A technique includes using multiple processing cores of a semiconductor package to perform functions directed to booting up a computer system.

### BACKGROUND

The invention generally relates to hierarchical parallelism for system initialization.

A typical computer system executes firmware called a basic input/output system (BIOS) for purposes of booting up the system. More specifically, through the execution of the BIOS, the computer system detects, tests and configures platform hardware in preparation for subsequent phases of firmware execution and the eventual launch of its operating system. The bootup of the computer system typically involves the testing of memory, which may take a relatively long time and thus, may significantly contribute to the overall boot up time of the computer system.

Thus, there is a continuing need for better ways to boot up a computer system.

### BRIEF DESCRIPTION OF THE DRAWING

FIGS. 1, 6 and 7 are schematic diagrams of computer systems according to embodiments of the invention.

FIG. 2 is a flow diagram depicting a technique to boot up a computer system according to an embodiment of the invention.

FIG. 3 is a schematic diagram of an arrangement of processing cores according to an embodiment of the invention.

FIG. 4 is a flow diagram depicting a technique used by a bootstrap processing core during boot up of a computer system according to an embodiment of the invention.

FIG. 5 is a flow diagram depicting a technique used by an application processing core during boot up of a computer system according to an embodiment of the invention.

### DETAILED DESCRIPTION

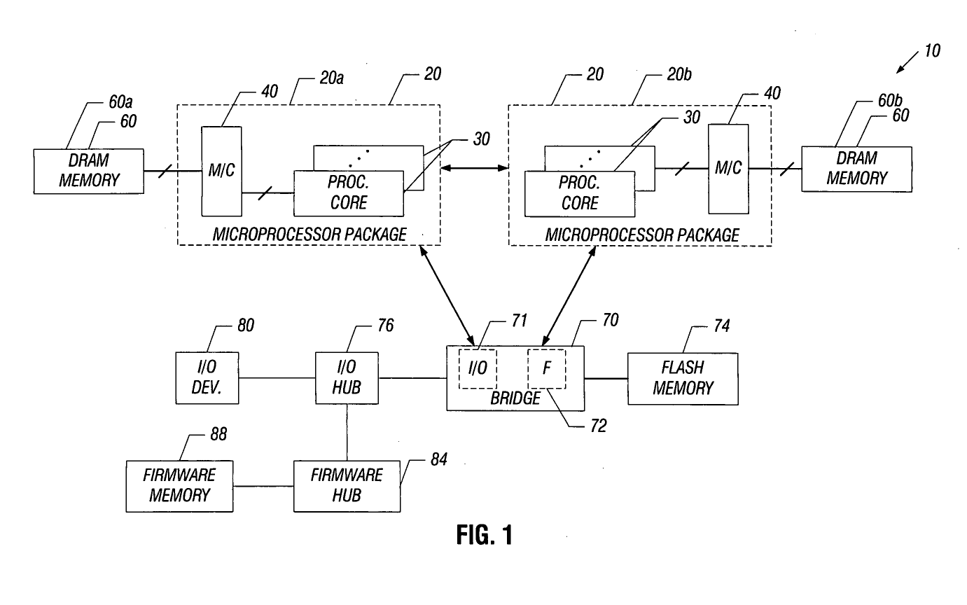

Referring to FIG. 1, in accordance with some embodiments of the invention, a computer system 10 includes microprocessor packages 20 (microprocessor packages 20a and 20b, being depicted as examples), each of which includes multiple instruction execution units, or processing cores 30 (i.e., the microprocessor packages are “multicore” devices). The microprocessor package 20, as its name implies, includes a semiconductor package, such as a Ball Grid Array (BGA) package (as an example), which resides in a dedicated socket in the computer system 10. In accordance with some embodiments of the invention, the processing cores 30 of each microprocessor package 20 may be formed on a monolithic semiconductor die, although the processing cores 30 may be formed on multiple dies inside the microprocessor package 20, in accordance with other embodiments of the invention.

In accordance with some embodiments of the invention, each microprocessor package 20 may have an external local, or associated, memory 60 (such as a dynamic random access (DRAM) memory, for example) in the computer system 10; and thus, each processor package 20 may be responsible for controlling the storage and retrieval of data from its local memory 60. The memories 60a and 60b are depicted as specific examples of the memory 60 in FIG. 1. As a more specific example, the microprocessor package 20a may “own” the memory 60a and be responsible for configuring the memory 20a, and the microprocessor package 20b may “own” the memory 60b and be responsible for configuring the memory 20b. The microprocessor packages 20a and 20b may also be capable of accessing the other memory 60a, 60b that is not owned by the microprocessor package 20a, 20b. Thus, in accordance with some embodiments of the invention, the computer system 10 may be a non-uniform memory access (NUMA) architecture.

In general, the NUMA architecture is a type of parallel processing architecture in which each processor (such as each microprocessor package 20) has its own local memory (such as the local memory 60a or 60b) and also can access the local memory 60 that is owned by another processor. The “non-uniform” aspect of the NUMA architecture refers to memory access times being faster when a processor accesses its own memory than when the processor borrows memory from another processor.

Collectively, the memories 60a and 60b may form a system memory for the computer system 10. For purposes of accessing its associated memory 60a, 60b, each microprocessor package 20 may include a memory controller 40, in accordance with some embodiments of the invention.

As described in more detail below, one of the processing cores 30 of each microprocessor package 20 is a dedicated bootstrap processing core, which initializes an associated part of the computer system 10 during the bootup of the system 10. The boot services that are performed by each bootstrap processing core 30 may include detecting, testing and configuring certain hardware of the computer system 10 and the subsequent launching of an operating system. If not for features described herein, the remaining processing core(s) 30 (herein called “the application processing cores”) of each processor package 20 may remain idle during the bootup of the computer system 10. It has been discovered, however, that if the application processing cores 30 remain idle, the boot up of the computer system 10 may be significantly prolonged. Therefore, in accordance with embodiments of the invention described herein, the application processing core(s) 30 of each microprocessor package 20 perform bootup-related functions during the bootup of the computer system 10, a feature of the system 10, which expedites the system's bootup time.

Among the other features of the computer system 10, in accordance with some embodiments of the invention, the computer system 10 may include a bridge 70, which represents interfaces for establishing communication between the microprocessor packages 20 and the other components of the computer system 10. For example, in accordance with some embodiments of the invention, the bridge 70 includes an input/output (I/O) interface 71 for purposes of establishing communication between the processor packages 20 and an I/O hub 76. The I/O hub 76, in turn, provides an interface for I/O devices 80 and a firmware hub 84, which controls the storage and retrieval of firmware in a firmware memory 88. The bridge 70 may also include, for example, a flash memory interface 72, which controls the storage and retrieval of data from a flash memory 74. It is noted that the architecture that is depicted in FIG. 1 is merely an example for purposes of illustrating one out of many possible embodiments of the invention.

In accordance with some embodiments of the invention, the application processing cores 30 collectively perform a memory test during the bootup of the computer system 10. In conventional systems, the BIOS may offer an option to bypass a thorough memory test, as the memory test typically represents a significant portion of the overall bootup time and thus, significantly speeds up the boot process if the memory test is bypassed. However, this bypass may not be desirable, in that the system may be running one or more defective memory devices. The defective memory might, for example, cause data corruption and/or other difficult to diagnose problems at the run time.

In accordance with embodiments of the invention described herein, the application processing cores are used to perform a memory test. Therefore, instead of remaining idle during the bootup of the computer system 10, the application processing cores perform a memory test to thoroughly diagnose the memory, while speeding up the overall bootup time.

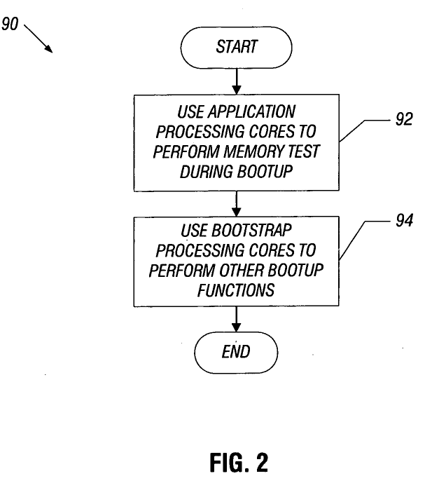

More specifically, in accordance with some embodiments of the invention, the computer system 10 may perform a technique 90, which is generally depicted in FIG. 2. Referring to FIG. 2 in conjunction with FIG. 1, pursuant to the technique 90, the computer system 10 uses (block 92) application processing cores 30 to perform a memory test during bootup, and the bootstrap processing cores 30 are used (block 94) to perform other bootup functions. Thus, all of the processing cores 30 are used to perform memory tests in parallel with other system initialization tasks.

In accordance with some embodiments of the invention, each microprocessor package 20 configures its local memory 60 so that the local configuration of memory is performed in parallel.

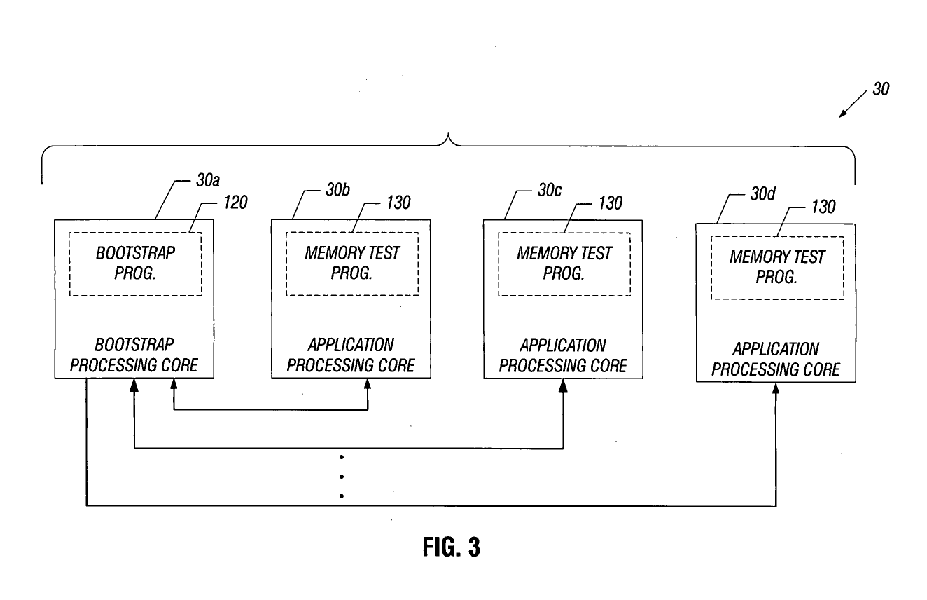

FIG. 3 generally depicts an arrangement 30 of processing cores 30 in an exemplary microprocessor package 20 in accordance with some embodiments of the invention. In the arrangement 30, a bootstrap processing core 30a controls the overall bootup process, while delegating the memory test to application processing cores, which includes three application processing cores 30b, 30c and 30d, in this example. The bootstrap processing core 30a executes a bootstrap program 120, and each of the application processing cores 30b, 30c and 30d execute a memory test program 130.

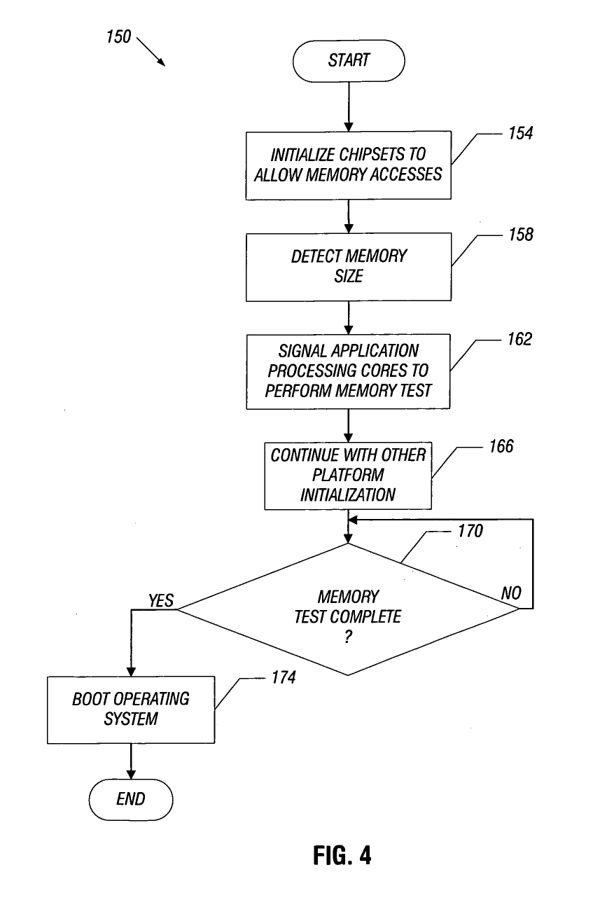

As a more specific example, in accordance with some embodiments of the invention, the execution of the bootstrap program 120 by the bootstrap processing core 30a may cause the core 30a to perform a technique 150, which is depicted in FIG. 4. Referring to FIG. 4 in conjunction with FIG. 3, via to the technique 150, the bootstrap processing core 30a initializes (block 154) chipsets of the computer system 10 to allow memory accesses. Next, the bootstrap processing core 30a detects memory sizes, as depicted in block 158. Subsequently, the bootstrap processing core 30a signals (block 162) the application processing cores 30b, 30c and 30d to perform the memory test. While the application processing cores 30b, 30c and 30d are performing the memory test, the bootstrap processing core 30a continues (as depicted in block 166) with other platform initialization functions. After the bootstrap processing core 30a determines (diamond 170) that the memory test is complete, the bootstrap processing core 30a boots (block 174) the operating system.

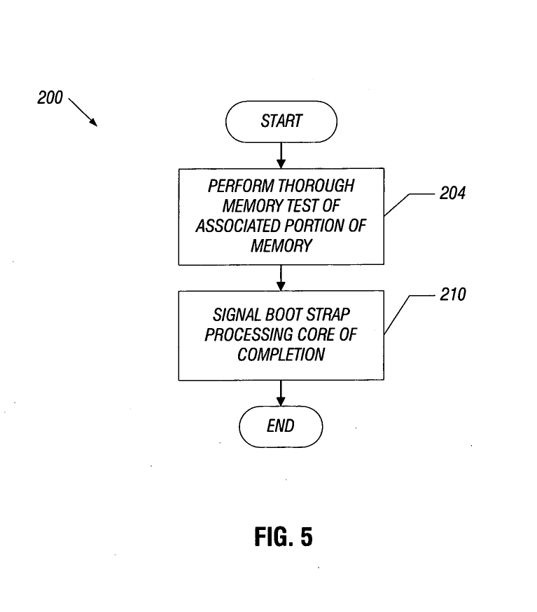

Each of the application processing cores 30b, 30c and 30d may perform a technique 200, which is generally depicted in FIG. 5, during the bootup of the computer system 10, in response to receiving a signal (such as an interrupt signal) that originates with the bootstrap processing core 30a for purposes of beginning the memory test. Referring to FIG. 5, pursuant to the technique 200, the application processing cores 30b, 30c and 30d each perform (block 204) a thorough memory test of its associated portion of memory. For example, referring to FIG. 1, in accordance with some embodiments of the invention, the application processing cores 30 of the processor package 20 perform a thorough test of its associated DRAM memory 60, and the application processing cores 30 of the processor package 20b perform a thorough memory test of its associated memory 60. As each processing core 30b, 30c and 30d completes its memory test, the application processing core 30b, 30c and 30d signals (pursuant to block 210) the bootstrap processing core 30a of its completion. Thus, when the bootstrap processing core 30a receives signals from all of its application processing cores 30b, 30c and 30d, then the bootstrap processing core 30a continues with the launch of the operating system, pursuant to the technique 150 (see FIG. 4).

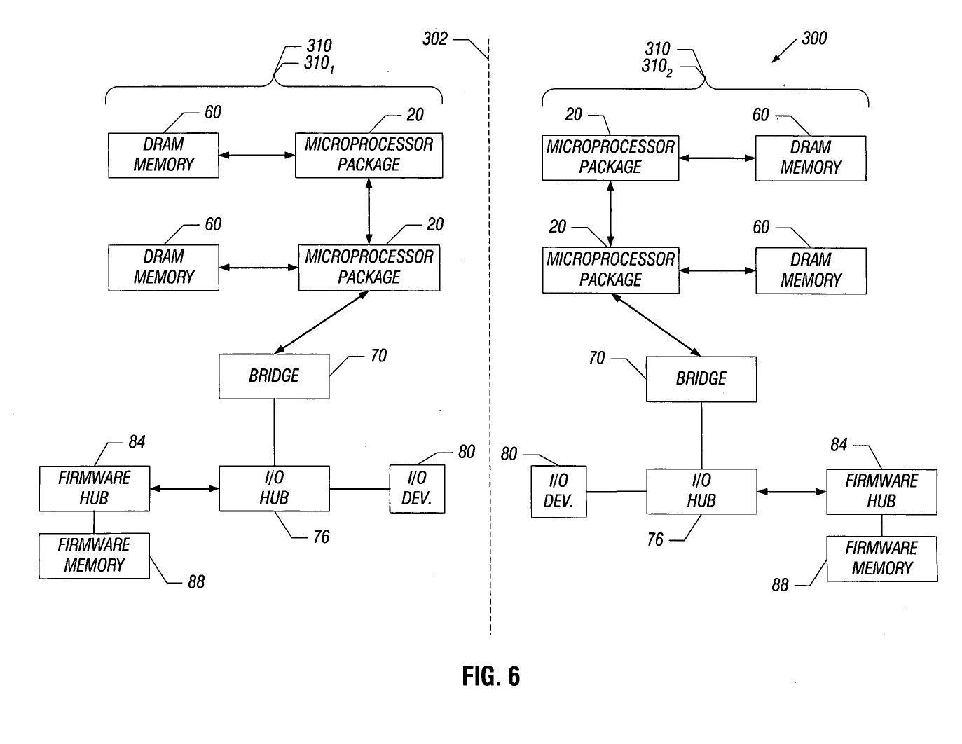

Various other embodiments are within the scope of the appended claims. For example, computer system 10 of FIG. 1 may be replaced by computer system 300, which is depicted in FIG. 6 in accordance with other embodiments of the invention. Referring to FIG. 6, the computer system 300 is a partitioned system, conceptually illustrated by a partition 302, which establishes dependent computer systems 310, such as exemplary computer systems 310₁ and 310₂. The computer systems 310₁ and 310₂ are part of the same platform (desktop, server, etc.) However, effectively two or more independent computer systems are created on this platform. Thus, each of the computer systems 310₁ and 310₂ may effectively have the same architecture as the computer system 10 (see FIG. 1). The microprocessor packages 20 of the system 300 each includes bootstrap and application processing cores that participate in the bootup of the computer system 300, as described herein.

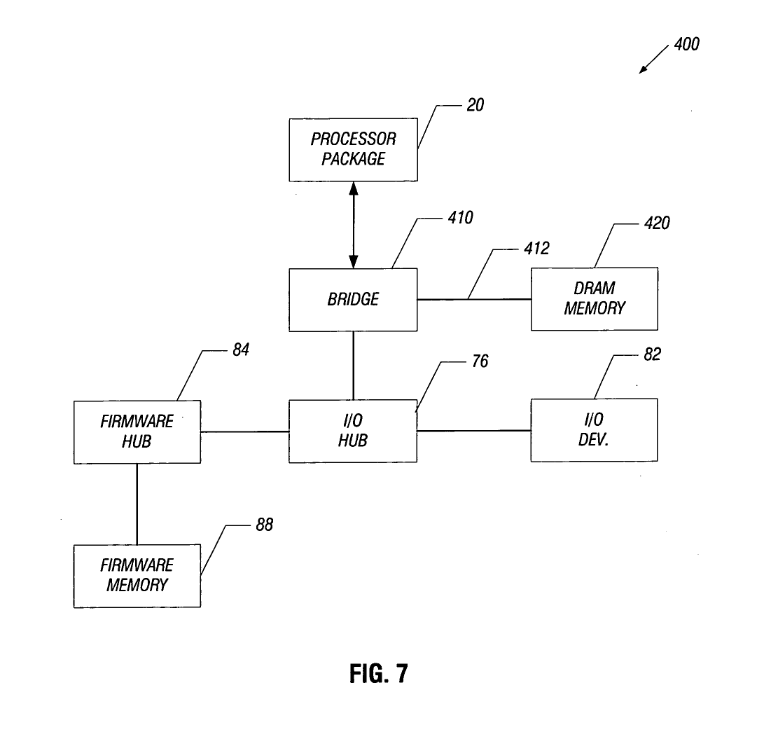

Referring to FIG. 7, as yet another example of an additional embodiment of the invention, a computer system 400 includes a single processor package 20. In this architecture, the processor package 20 accesses a memory 420 (such as a DRAM memory, for example) through a bridge 410 that establishes communication between the processor package 20 and a memory bus 412 via a memory controller that is part of the bridge 410. The bridge 410 also establishes communication between the DRAM memory 420, processor package 20 and an I/O hub 76. The I/O hub 76 establishes communication with I/O devices 82 and a firmware hub 84, which controls storage and retrieval of data from a firmware memory 88. The processor package 20 includes a bootstrap processing core and application processing cores, which all participate in the bootup of the computer system 400, as described herein for the system 10.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
using multiple processing cores of a semiconductor package to perform functions directed to booting up a computer system.

2. The method of claim 1, wherein the act of using comprises:
using a first processing core to perform a memory check; and
using a second processing core other than the first processing core to perform a bootup function other than performing a memory check.

3. The method of claim 2, wherein the act of using the second processing core comprises:
using the second processing core to initialize chipsets to allow memory accesses.

4. The method of claim 2, wherein the act of using the second processing core comprises:
using the second processing core to boot an operating system.

5. The method of claim 2, wherein the act of using comprises:
using the first processing core to perform the memory check in response to a communication from the second processing core.

6. The method of claim 1, wherein the act of using comprises:
using a first processing core to perform a memory check; and
using second processing cores other than the first processing core to perform a bootup function other than performing a memory check.

7. The method of claim 6, wherein the using the first processing core to perform a memory check comprises performing a memory check of a local memory to the semiconductor package.

8. An apparatus comprising:
a semiconductor package; and
multiple processing cores contained in the semiconductor package, the multiple processing cores to perform functions directed to booting up a computer system.

9. The apparatus of claim 8, wherein the semiconductor package comprises a ball grid array semiconductor package.

10. The apparatus of claim 8, wherein the multiple processing cores comprises instruction execution units.

11. The apparatus of claim 8, wherein the multiple cores comprise:
a first processing core to perform a memory check; and
a second processing core other than the first processing core to perform a bootup function other than performing a memory check.

12. The apparatus of claim 11, wherein the second processing core initializes chipsets to allow memory accesses.

13. The apparatus of claim 11, wherein the second processing core boots an operating system.

14. The apparatus of claim 8, wherein the multiple processing cores comprise:
a first processing core to perform a memory check; and
second processing cores other than the first processing core to perform a bootup function other than performing a memory check

15. The apparatus of claim 14, wherein the first processing core performs a memory check on memory local to the semiconductor package.

16. A system comprising:
a dynamic random access memory;
a semiconductor package; and
multiple processing cores housed by the package and comprising:
at least one processing core to perform a memory test of the dynamic random access memory in response to a bootup of the system; and
a processing core other than said at least one processing core to perform functions directed to booting up the system other than the memory test.

17. The system of claim 16, wherein the multiple processing cores comprises central processing unit cores.

18. The system of claim 16, wherein said processing core other than said at least one processing core initializes chipsets to allow memory accesses.

19. The system of claim 16, wherein said processing core other than said at least one processing core boots an operating system.

20. The system of claim 16, further comprising:
additional semiconductor packages, each of the additional semiconductor packages comprising multiple processing cores to perform functions directed to booting up the system.

21. An article comprising a computer accessible storage medium storing instructions that when executed cause a computer to:
use multiple processing cores of a semiconductor package to perform functions directed to booting up a computer system.

22. The article of claim 21, the storage medium storing instructions that when executed cause the computer to::
use a first processing core of the multiple processing cores to perform a memory check; and
use a second processing core of the multiple processing cores other than the first processing core to perform a bootup function other than performing a memory check.

23. The article of claim 22, the storage medium storing instructions that when executed cause the computer to:
use the second processing core to initialize chipsets to allow memory accesses.

24. The article of claim 22, the storage medium storing instructions that when executed cause the computer to:
use the second processing core to boot an operating system.

25. The article of claim 21, the storage medium storing instructions that when executed cause the computer to:
use a first processing core of the multiple processing cores to perform a memory check; and
use second processing cores of the multiple processing cores other than the first processing core to perform a bootup function other than performing a memory check.
